(19) United States
(12) Patent Application Publication
(10) Pub. No.: US 2004/0185252 A1
(43) Pub. Date: Sep. 23, 2004

(54) Functionalisation of unreactive substrates

(76) Inventors: Frank Schilke, Weiterstadr (DE); Berthold Nies, Fraenkisch-Crumabch (DE); Brigitte Jeschke, Kelkheim (DE); Matthias Koch, Wiesbaden (DE); Armin Kuebelbeck, Bensheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/740,913

(22) Filed: Dec. 22, 2003

(30) Foreign Application Priority Data
Dec. 20, 2002 (DE) 10260918.7
Sep. 2, 2003 (DE) 10340800.2

(51) Int. Cl. B05D 1/36

(52) U.S. Cl. 428/407; 427/214; 427/402

(57) ABSTRACT

The invention describes a process for the production of functionalised unreactive substrates in which the surface of the substrate is firstly coated with a melamine-formaldehyde resin and subsequently reacted with a functionalising reagent.

The invention relates to a process for the production of functionalised substrates and to an inorganic or organic moulding.

The process according to the invention is a parallel development of the process described in DE 10260918.7 (“Bone cement having improved mechanical properties, and process for the preparation thereof”) and claims the priority thereof. Furthermore, the process according to the invention is a further development of the process described in DE 102 09 359.8.

Composite materials are used in many areas of industry. Examples are pigments in surface coatings, fillers for improving the material properties of plastics or dispersions of solid particles in aqueous or non-aqueous liquids. It is often necessary here for chemically and physically different materials to be mixed with one another. A homogeneous distribution is usually only achieved by compatibilisation of the filler material. For example, the properties of silicon dioxide surfaces (glasses), as known to the person skilled in the art, can be changed by reaction with appropriate silanes.

However, this functionalisation requires a certain reactivity of the surface, which is not the case for many substrates. Inorganic pigments based on metal oxides often cannot be modified by this method owing to poor reactivity.

The object of the present invention was therefore to develop a process which sufficiently activates unreactive substrates by means of special coatings in order subsequently to functionalise the substrates.

This object is achieved by a process for the production of functionalised (unreactive) substrates in which the surface of the substrate is firstly coated with a melamine-formaldehyde resin as reactive interlayer and subsequently reacted with a functionalising reagent.

The term “unreactive substrates” means that these substrates can only be functionalised with difficulty, or not at all. Suitable substrates are inorganic or organic mouldings of any desired geometry for plastics, metals, glass, ceramic, etc., a particulate material being preferred. Greater preference is given to substrates which are used as pigments or fillers for plastic materials.

A suitable reactive interlayer is melamine-formaldehyde resin (commercially available, for example, as Madurit® from Solutia GmbH, Wiesbaden), which can easily be applied to any desired substrates. Acid-catalysed three-dimensional crosslinking results in the formation of a solid coating which adheres strongly to the substrate even without chemical bonding thereto. This process is described in detail in DE 102 09 359.8. The process described in DE 102 10 779.3 enables coating with melamine-formaldehyde resin instead of adding acid to be initiated through the addition of hydrogen peroxide solution.

The melamine-formaldehyde resin layer allows functionalisation with a series of commercially available, inexpensive (compared with silanes) reagents and thus efficient, inexpensive compatibilisation of a very wide variety of materials. Furthermore, particles functionalised in this way can be employed as support materials for immobilisation.

The process preferably consists of the following steps:

a) suspension of the substrate in water

b) addition of melamine-formaldehyde resin

c) addition of an acid, preferably formic acid or p-toluenesulfonic acid

d) washing and drying of the melamine-formaldehyde resin-coated substrate

e) reaction with a functionalising reagent, preferably with an acid chloride, acid anhydride, acid azide, active ester, aldehyde or ester

f) washing and drying of the functionalised substrate.

In addition to the functionalisation, the production of core/shell particles is possible in accordance with the invention in the following steps:

a) suspension of the unreactive particles in water and subsequent heating

b) addition of melamine-formaldehyde resin

c) addition of an acid, such as, for example, formic acid

d) washing and drying of the melamine-formaldehyde resin-coated particles

e) addition of an acid halide as functionalising reagent at room temperature with stirring

f) washing and drying of the functionalised particles

g) addition of a metal halide (for example copper bromide), a metal-complexing reagent (for example 4,4′-di-(5-nonyl)-2,2′-bipyridine) and a free-radical-polymerisable monomer, such as styrene, and suspension in toluene with subsequent heating

h) washing with alcohol and drying of the particles.

The initiator groups are applied by the functionalisation method according to the invention via acid halides to the cores by the known ATRP (atom transfer radical polymerisation) method or related processes. Suitable in principle are all common polymerisation processes which build up the chains in a controlled manner (free-radical, anionic, cationic or metal-catalysed) after functionalisation of the substrate with the corresponding initiator groups.

Preference is furthermore given to a process for the production of core/shell particles in which a polymer layer, such as polyethylene oxide, is applied to the melamine-formaldehyde resin-coated substrate by polymerisation of an epoxide compound, such as ethylene oxide.

The melamine surface possesses reactive methylol groups, which can be reacted particularly well with acid chlorides, acid anhydrides and esters. However, acid azides, active esters or aldehydes are also suitable. Depending on the desired surface properties, the following functionalisations are conceivable:

hydrophobicisation with long-chain alkyl radicals in the form of esters of aliphatic acids

lipophobicisation with perfluorinated radicals

esters of acrylic acids or vinylbenzoic acids for free-radical polymerisation of the substrates into polymer matrices

alkenyl ethers for polymerisation by the Ziegler-Natta and related processes

esterification with isonicotinoyl chloride or similar compounds for the generation of a basic surface

hydrophilisation with polyethylene oxide (grafting from: build-up of the polymer chain away from the substrate)

esters of isobutyryl halides and related compounds as ATRP initiator; generation of defined polymer layers by means of free-radical polymerisation (core/shell particles)

### EXAMPLES

1. Functionalisation of an Iron Pigment Using Lauroyl Chloride:

300 g of Iriodin 504® iron pigment (Merck) are slurried in 5 l of water and heated to 70° C. 225 g of Madurit® SMW 818 75% (melamine-formaldehyde resin from Solutia Germany) are added with stirring. When all the Madurit® has dissolved, 500 ml of 2% formic acid are added in one portion, and the mixture is stirred for 30 minutes. The product is filtered off with suction and washed with water.

100 g of the iron pigment coated in this way are refluxed overnight in 250 ml of lauroyl chloride. The product is filtered off with suction and washed with water, giving a hydrophobicised pigment.

2. Functionalisation of Zirconium Oxide Using Methacrylic Anhydride:

100 g of zirconium oxide (Selectipur, Merck) are slurried in 5 l of water and heated to 70° C. 150 g of Madurit MW 909 (Solutia Germany) are added with stirring. When all the Madurit® has dissolved, 300 ml of 2% formic acid are added in one portion, and the mixture is stirred for 30 minutes. The product is filtered off with suction and washed with water.

10 g of the zirconium oxide coated in this way are slurried in 50 ml of methacrylic anhydride (containing 2% of hydroxyquinone monomethyl ether) and refluxed overnight. The product is filtered off with suction and washed with ethanol, giving copolymerisable zirconium oxide.

3. Functionalisation of Zirconium Oxide Using Acetyl Chloride:

50 g of zirconium oxide (particle diameter about 50 nm) are slurried in 10 l of water and heated to 70° C. 100 g of Madurit MW 909 (Solutia Germany) are added with stirring. When all the Madurit® has dissolved, 200 ml of 10% formic acid are added in one portion, and the mixture is stirred for 30 minutes. The product is centrifuged off and washed with water.

10 g of the zirconium oxide coated in this way are stirred overnight at room temperature in 50 ml of acetyl chloride. The product is filtered off with suction and washed with ethanol, giving hydrophobicised, nanoscale zirconium chloride.

4. Production of a Core/shell Particle by Functionalisation Using Bromoisobutyryl Bromide:

5 g of melamine-formaldehyde resin-coated particles are stirred overnight at room temperature in 15 ml of bromoisobutyryl bromide. The particles are filtered off with suction, washed with ethanol and dried.

1 g of these functionalised particles is suspended in 50 ml of toluene together with 75 mg of CuBr, 400 mg of 4,4′-di-(5-nonyl)-2,2′-bipyri-dine (=metal-complexing reagent) and 7.5 g of styrene with vigorous stirring and heated to 100° C. The core/shell particles are washed with methanol and dried, giving a colourless, light powder.

1. Process for the production of functionalised substrates, characterised in that the surface of the substrate is firstly coated with a melamine-formaldehyde resin and subsequently reacted with a functionalising reagent.

2. Process according to claim 1, characterised in that the production of functionalised substrates comprises the following steps:
a) suspension of the substrate in water
b) addition of melamine-formaldehyde resin
c) addition of an acid
d) washing and drying of the melamine-formaldehyde resin-coated substrate
e) reaction with a functionalising reagent
f) washing and drying of the functionalised substrate.

3. Process according to claims 1 and/or 2, characterised in that the substrate employed is a chemically unreactive substrate.

4. Process according to claim 3, characterised in that the unreactive substrate used is a particulate inorganic or organic material.

5. Process according to claim 3, characterised in that the unreactive substrate used is a pigment or filler for plastic materials.

6. Process according to one of claims 1 to 5, characterised in that the functionalising reagent used is an acid chloride, acid anhydride, acid azide, active ester, aldehyde or ester.

7. Process for the production of core/shell particles from an unreactive substrate, characterised in that the production comprises the following steps:
a) suspension of the unreactive particles in water and subsequent heating
b) addition of melamine-formaldehyde resin
c) addition of an acid
d) washing and drying of the melamine-formaldehyde resin-coated particles
e) addition of an acid halide as functionalising reagent at room temperature with stirring
f) washing and drying of the functionalised particles
g) addition of a metal halide, a metal-complexing reagent and a free-radical-polymerisable monomer and suspension in toluene with subsequent heating
h) washing and drying of the particles.

8. Process for the production of core/shell particles according to claim 7, characterised in that a polymer layer, such as polyethylene oxide, is applied to the melamine-formaldehyde resin-coated substrate by polymerisation of an epoxide compound, such as ethylene oxide.

9. Inorganic or organic moulding, obtainable by the process according to one of claims 1 to 8.

10. Inorganic or organic moulding according to claim 9, characterised in that it is a particulate substrate.

11. Inorganic or organic moulding according to claim 9 and/or 10, characterised in that it is a pigment or filler for plastic materials.
